(19) United States
(12) Patent Application Publication
(10) Pub. No.: US 2011/0043415 A1
(43) Pub. Date: Feb. 24, 2011

(54) DUAL-BAND ANTENNA AND WIRELESS COMMUNICATION DEVICE USING THE SAME

(75) Inventor: KE-KUN CHANG, Taipei (TW)

Correspondence Address: Altis Law Group, Inc.;ATTN: Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/618,091

(22) Filed: Nov. 13, 2009

(30) Foreign Application Priority Data
Aug. 18, 2009 (CN) 200910305716.1

(51) Int. Cl. H01Q 1/36; H01Q 1/24; H01Q 1/48

(52) U.S. Cl. 343/702; 343/700 MS; 343/846

(57) ABSTRACT

A dual-band antenna used in a wireless communication device includes a radiating body, a grounding portion, and feeding portion. The radiating body includes a first radiating portion and a second radiating portion connected to the first radiating portion. The grounding portion is connected to the first radiating portion. The feeding portion is also connected to the first radiating portion, and parallel to the grounding portion. The first radiating portion receives/sends wireless signals at a first frequency band. The second radiating portion receives/sends wireless signals at a second frequency band.

### BACKGROUND

1. Technical Field

The disclosure generally relates to antennas, particularly to a dual-band antenna and a wireless communication device using the dual-band antenna.

2. Description of Related Art

Antennas are important components of wireless communication devices such as mobile phones and personal digital assistants (PDAs) used for transmitting/receiving signals. Wireless communication devices usually need a dual-band or multi-band antenna to communicate at different frequency bands.

Referring to FIG. 5, a conventional dual-antenna 80 includes a first radiating arm 82 and a second radiating arm 84. The first radiating arm 82 and the second radiating arm 84 are strips. Therefore, the conventional dual-antenna 80 usually occupies considerable space when installed in a wireless communication device, and makes it difficult to meet the miniaturization trend of wireless communication devices.

Therefore, there is room for improvement within the art.

### BRIEF DESCRIPTION OF THE DRAWINGS

Many aspects of the dual-band antenna and wireless communication device can be better understood with reference to the following drawings. The components in the drawings are not necessarily drawn to scale, the emphasis instead being placed upon clearly illustrating the principles of the dual-band antenna and the wireless communication device.

FIG. 1 shows a schematic view of a dual-band antenna mounted on a baseboard, according to an exemplary embodiment.

FIG. 2 shows a schematic view of the dual-band antenna and the baseboard of FIG. 1 mounted on a mobile phone.

FIG. 3 shows an exemplary dimension of the dual-band antenna of FIG. 1.

FIG. 4 shows a table of the gains of the dual-band antenna of FIG. 1 at frequency of 2400 MHz, 2450 MHz, 2500 MHz, 5400 MHz, 5600 Hz, and 6000 Hz.

FIG. 5 shows a schematic view of a conventional dual-band antenna.

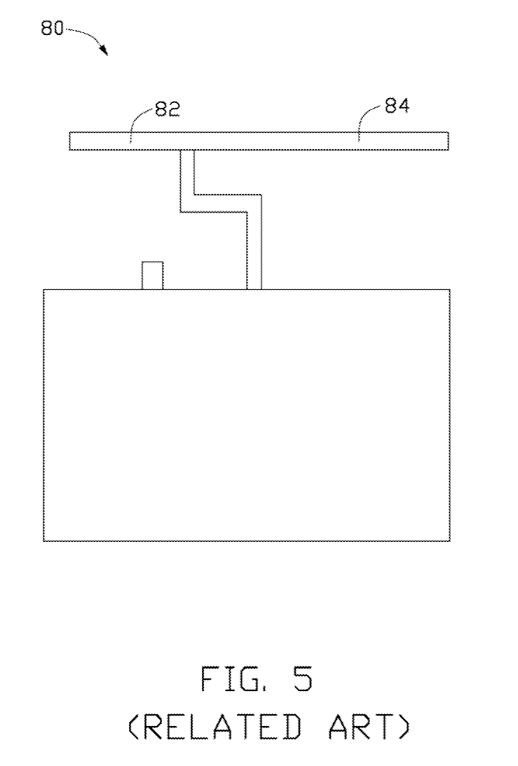

### DETAILED DESCRIPTION

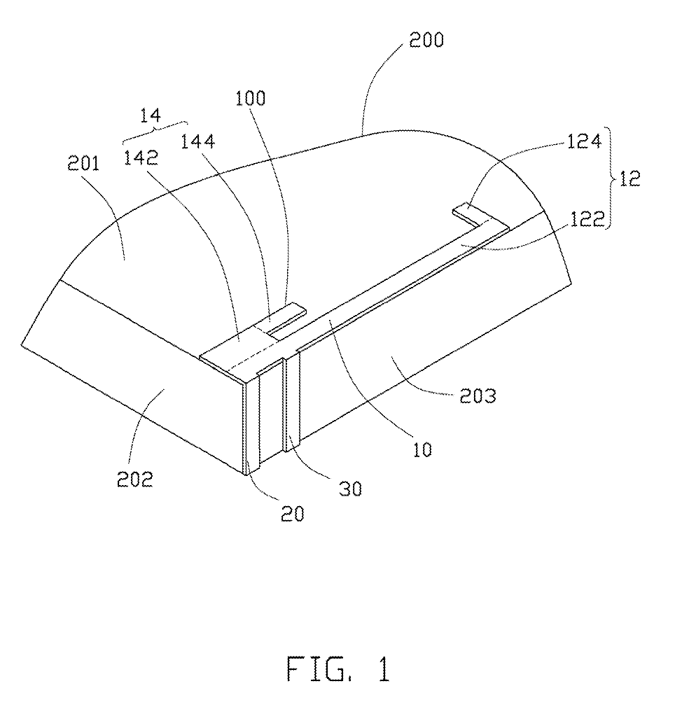

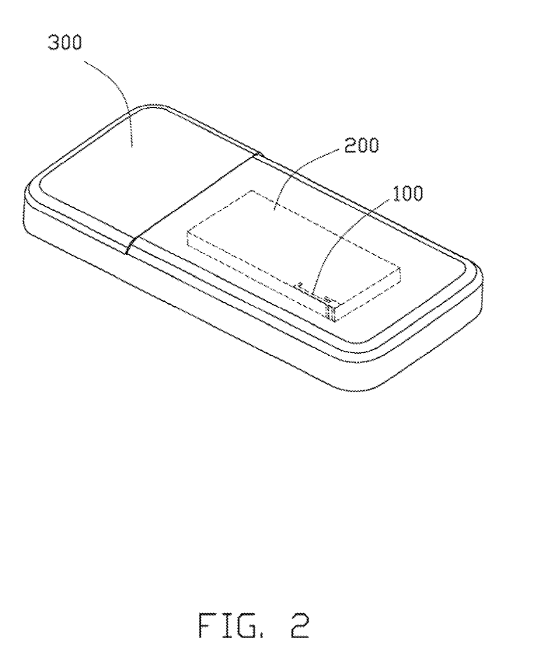

Referring to FIGS. 1-2, a dual-band antenna 100 is disposed on a baseboard 200 of a wireless communication device 300 such as a mobile phone or personal digital assistant. The dual-band antenna 100 includes a radiating body 10, a grounding portion 20, and a feeding portion 30 connected to the radiating body 10 for receiving/sending signals.

The radiating body 10 includes a first radiating portion 12 and a second radiating portion 14 connected to the first radiating portion 12. The first radiating portion 12 is an L-shaped sheet including a first band section 122 and a second band section 124 shorter than the first band section 122. The second band section 124 is perpendicularly connected to one end of the first band section 122. The second radiating portion 14 is also an L-shaped sheet including a connecting section 142 and an extending section 144. The connecting section 142 is perpendicularly connected to one end of the first band section 122, and parallel to the second band section 124. The extending section 144 is perpendicularly connected to the connecting section 142, and parallel to the first band section 122 with a space between them.

The grounding portion 20 and the feeding portion 30 are both strip-shaped sheet. One end of the grounding portion 20 is perpendicularly connected to the end of the first band section 122 opposite to the second band section 124. The feeding portion 30 is perpendicularly connected to one side of the first band section 122, and parallel to the grounding portion 20. A gap (not labeled) is defined between the grounding portion 20 and the feeding portion 30.

The baseboard 200 is a printed circuit board (PCB) in the wireless communication device 300 used to support and protect the dual-band antenna 100. The baseboard 200 includes a top surface 201, a first side surface 202, and a second side surface 203. The first side surface 202 and the second side surface 203 are perpendicularly extended from two adjacent edges of the top surface 201. The first side surface 202 is perpendicularly connected to the second side surface 203. A feeding point (not shown) and a grounding point (not shown) are set on the second side surface 203.

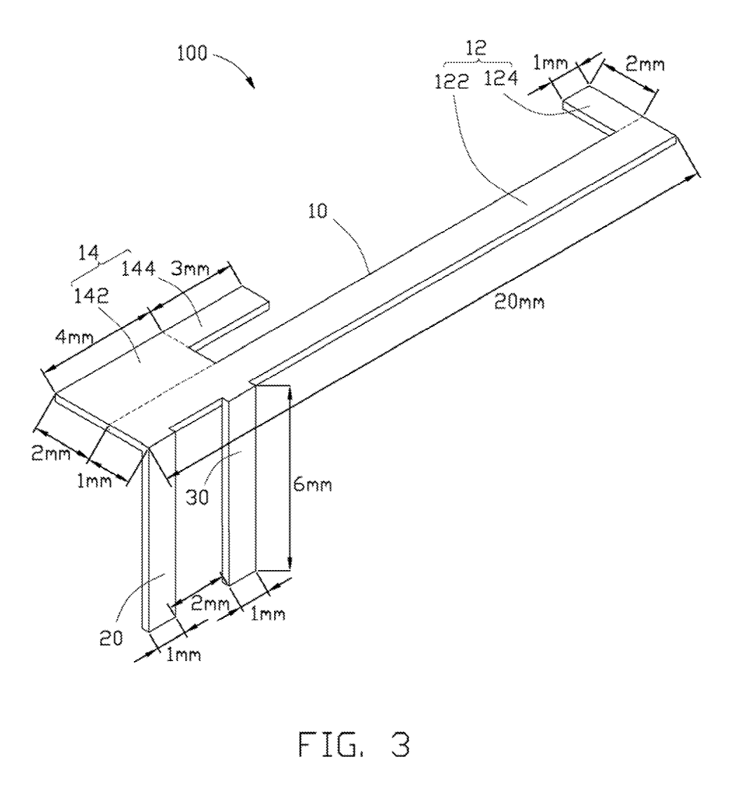

Referring to FIG. 3, in an exemplary embodiment, the length of the first band section 122 and the first band section 124 can be 20 mm and 2 mm, respectively. The width of the first band section 122 and the first band section 124 can be 1 mm. The length of the connecting section 142 and the extending section 144 can be 4 mm and 3 mm, respectively. The width of the connecting section 142 and the extending section 144 can be 2 mm and 1 mm. The length and width of the grounding portion 20 and the feeding portion 30 can be 6 mm and 1 mm, respectively. The width between the grounding portion 20 and the feeding portion 30 can be 2 mm. These dimensions are merely exemplary and do not limit to the scope of the embodiment. The dimensions of the various antenna portions are related to the wavelength of the desired electronic signals the antenna will transmit or receive.

During assembly, the radiating body 10 is mounted on the top surface 201 of the baseboard 200. The grounding portion 20 and the feeding portion 30 can be mounted on the side surface 203 of the baseboard 200, and respectively connected to the grounding point and feeding point thereon. In work, the dual-band antenna 100 receives the signals from the feed point via the feeding portion 30, and forms a first circuit path and a second circuit path having different electrical lengths. The first circuit path is from the feeding portion 30 to the first radiating portion 12. The second circuit path is from the feeding portion 30 to the second radiating portion 14. As is well known, signals at different frequencies have different wavelengths correspondingly. When the electrical lengths of the first circuit path and the second circuit path can be equal to ¼ of the wavelength of a signal, the corresponding first radiating portion 12 or the second radiating portion 14 can transmit and receive the corresponding signals.

In this exemplary embodiment, the length of the first circuit path can be approximately 29 mm, and the first radiating portion 12 receives/sends wireless signals at a first frequency band of 2.4˜2.5 GHz. The length of the second circuit path can be approximately 13 mm, and the second radiating portion 14 receives/sends wireless signals at a second frequency band of 5.4˜5.9 GHz. The dual-band antenna 100 can be suitable for operating in wireless local area network communication systems such as IEEE 802.11a/b/g/n.

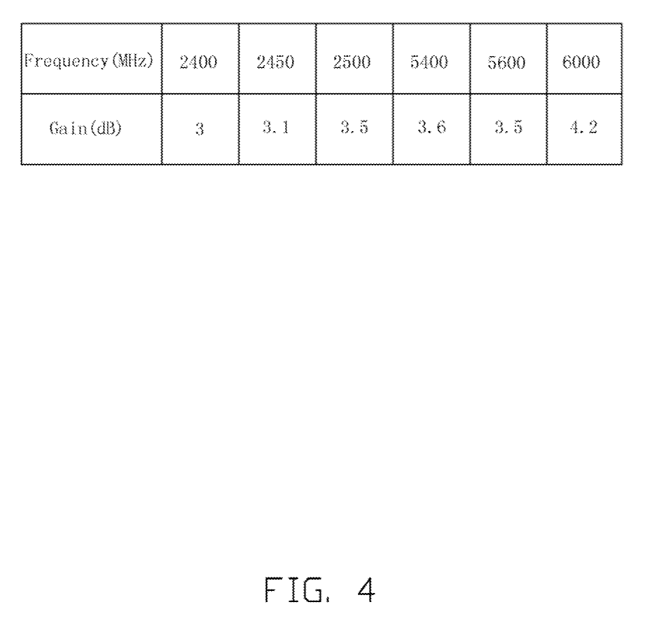

Referring to FIG. 4, when the dual-band antenna 100 is respectively used to transmit/receive signals in 2400 MHz, 2450 MHz, 2500 MHz, 5400 MHz, 5600 MHz, and 6000 MHz, the gains of the dual-band antenna 100 can be correspondingly 3 dB, 3.1 dB, 3.5 dB, 3.6 dB, 3.5 dB and 4.2 dB. In the above-mentioned frequency bands, the dual-band antenna 100 is applicable in wireless communication.

The outer dimensions of the dual-band antenna 100 is about 20 mm×3 mm×6 mm, and the dual-band antenna 100 does not occupy much space within wireless communication devices, which is advantageous to miniaturization of wireless communication devices. Furthermore, the dual-band antenna 100 provides two resonance frequencies via the first radiating portion 12 and the second radiating portion 14 suitable for two different communication systems, which reduces the cost of wireless communication device 300.

It is believed that the exemplary embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A dual-band antenna used in a wireless communication device, comprising:
a radiating body including a first radiating portion and a second radiating portion connected to the first radiating portion;
a grounding portion connected to the first radiating portion; and
a feeding portion connected to the first radiating portion, and parallel to the grounding portion; and wherein the first radiating portion receives/sends wireless signals at a first frequency band, and the second radiating portion receives/sends wireless signals at a second frequency band.

2. The dual-band antenna as claimed in claim 1, wherein the first radiating portion is an L-shaped sheet including a first band section and a second band section perpendicularly connected to the first band section.

3. The dual-band antenna as claimed in claim 2, wherein the second band section is an L-shaped sheet including a connecting section and an extending section connected to the connecting section, the connecting section is perpendicularly connected to one end of the first band section, and parallel to the second band section, and the extending section is parallel to the first band section with a space between them.

4. The dual-band antenna as claimed in claim 1, wherein the grounding portion is a strip-shaped sheet perpendicularly connected to the end of the first band section opposite to the second band section.

5. The dual-band antenna as claimed in claim 4, wherein the feeding portion is a strip-shaped sheet, perpendicularly connected to the first band section, and parallel to the grounding portion with a gap defined between them.

6. The dual-band antenna as claimed in claim 1, wherein the first frequency band is 2.4˜2.5 GHz.

7. The dual-band antenna as claimed in claim 1, wherein the second frequency band is 5.4˜5.9 GHz.

8. A wireless communication device, comprising:
a baseboard including a top surface, a first side surface, and a second side surface; and
a dual-band antenna mounted on the baseboard, the dual-band antenna comprising:
a radiating body mounted on the top surface including a first radiating portion and a second radiating portion connected to the first radiating portion;
a grounding portion mounted on the second side surface, and connected to the first radiating portion; and
a feeding portion mounted on the second side surface, connected to the first radiating portion, and parallel to the grounding portion; wherein the first radiating portion receives/sends wireless signals at a first frequency band, and the second radiating portion receives/sends wireless signals at a second frequency band.

9. The wireless communication device as claimed in claim 8, wherein every two surfaces of the top surface, the first side surface, and the second side surface can be perpendicular to each other.

10. The wireless communication device as claimed in claim 8, wherein the first radiating portion is an L-shaped sheet including a first band section and a second band section perpendicularly connected to the first band section.

11. The wireless communication device as claimed in claim 10, wherein the second band section is an L-shaped sheet including a connecting section and an extending section connected to the connecting section, the connecting section is perpendicularly connected to one end of the first band section, and parallel to the second band section, the extending section is parallel to the first band section with a space between them.

12. The wireless communication device as claimed in claim 8, wherein the grounding portion is a strip-shaped sheet perpendicularly connected to the end of the first band section opposite to the second band section.

13. The wireless communication device as claimed in claim 12, wherein the feeding portion a strip-shaped sheet perpendicularly connected to the first band section, and parallel to the grounding portion with a space between them.

14. The wireless communication device as claimed in claim 8, wherein the first frequency band is 2.4˜2.5 GHz.

15. The wireless communication device as claimed in claim 8, wherein the second frequency band is 5.4˜5.9 GHz.
